(19) United States
(12) Patent Application Publication
(10) Pub. No.: US 2025/0191038 A1
(43) Pub. Date: Jun. 12, 2025

(54) SERVICE PROVIDING SYSTEM, SERVER, ON-VEHICLE DEVICE, STORAGE MEDIUM STORING SERVICE PROVIDING PROGRAM, AND SERVICE PROVIDING METHOD

(71) Applicant: DENSO CORPORATION, Kariya-city (JP)

(72) Inventors: Hideyuki YAMAGUCHI, Kariya-city (JP); Kei Okada, Kariya-city (JP)

(21) Appl. No.: 19/032,390

(22) Filed: Jan. 20, 2025

Related U.S. Application Data
(63) Continuation of application No. PCT/JP2023/027049, filed on Jul. 24, 2023.

(30) Foreign Application Priority Data
Aug. 3, 2022 (JP) 2022-123987

(51) Int. Cl. G06Q 30/0283

(52) U.S. Cl. CPC G06Q 30/0284

(57) ABSTRACT

A service providing system includes a vehicle control system and a server. The vehicle control system implements coordination between a service-system functional block and a functional block. The functional block converts an access request expressed in a vehicle-independent format and transmitted from the service-system functional block into a vehicle-dependent format. The coordination control section transfers the access request to the functional block, and creates an access log. The server uses the access log to calculate an interface usage fee generated by the service-system functional block using the functional interface.

### CROSS REFERENCE TO RELATED APPLICATION

The present application is a continuation application of International Patent Application No. PCT/JP2023/027049 filed on Jul. 24, 2023 which designated the U.S. and claims the benefit of priority from Japanese Patent Application No. 2022-123987 filed on Aug. 3, 2022. The entire disclosures of all of the above applications are incorporated herein by reference.

### TECHNICAL FIELD

The present disclosure relates to a service providing system, a server, an on-vehicle device, a service providing program, and a service providing method for providing a service to a vehicle.

### BACKGROUND

A related art describes a vehicle including: a control section that operates the vehicle based on operation information received from a management server; a management section that manages a compartment of the vehicle for which a service user receives a service from a service provider; and an interface section that is set in association with service-related information provided by the service provider and the compartment.

### SUMMARY

A service providing system includes a vehicle control system and a server. The vehicle control system implements coordination between a service-system functional block and a functional block. The functional block converts an access request expressed in a vehicle-independent format and transmitted from the service-system functional block into a vehicle-dependent format. The coordination control section transfers the access request to the functional block, and creates an access log. The server uses the access log to calculate an interface usage fee generated by the service-system functional block using the functional interface.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating a configuration of a service providing system;

FIG. 2 is a block diagram illustrating a configuration of an electronic control device (ECU);

FIG. 3 is a block diagram illustrating a charging procedure;

FIG. 4A is a diagram illustrating a procedure for an application programming interface (API) contract;

FIG. 4B is a diagram illustrating information stored in a storage section;

FIG. 5 is a flowchart illustrating a log creation process according to the first embodiment;

FIG. 6 is a diagram illustrating a configuration of a statistical access log according to the first embodiment;

FIG. 7 is a sequence diagram illustrating a payment procedure;

FIG. 8 is a diagram illustrating a configuration of a statistical access log according to a second embodiment;

FIG. 9 is a diagram illustrating a configuration of an actuator operation type table;

FIG. 10 is a diagram illustrating a configuration of a sensor operation type table;

FIG. 11 is a flowchart illustrating a log creation process according to the second embodiment;

FIG. 12 is a flowchart illustrating a resource recording process; and

FIG. 13 is a flowchart illustrating an additional recording process.

### DETAILED DESCRIPTION

When a service provider provides a service to a vehicle, it may be necessary to acquire, from a target vehicle to be provided with the service, vehicle information on the vehicle or to cause the target vehicle to perform a predetermined operation or process.

As a result of the detailed study of the inventor, it was found that there are cases where, when the service provider uses the vehicle by acquiring vehicle information from the vehicle or causing the vehicle to perform a predetermined operation or process, it may be desirable to charge the service provider for the use.

The present disclosure provides a technique that enables a service provider to be charged for providing a service to a vehicle.

One aspect of the present disclosure is a service providing system including a vehicle control system that is mounted on a vehicle and includes a plurality of electronic control devices connected to an on-vehicle network, and a server configured to be capable of data communication with the vehicle control system.

The vehicle control system includes a coordination control section. The coordination control section is configured to implement coordination between a service-system functional block configured to provide a service to the vehicle and a functional block configured to execute a predetermined process in the vehicle.

The functional block includes a functional interface. The functional interface is configured to convert an access request expressed in a vehicle-independent format and transmitted from the service-system functional block into a vehicle-dependent format.

The coordination control section includes a request transfer section and an access log creation section.

The request transfer section is configured to transfer the access request transmitted from the service-system functional block to the functional block.

The access log creation section is configured to create, based on an execution status of the access request by each of the plurality of electronic control devices, an access log including at least one of an interface usage count or an amount of communication data generated by the service-system functional block using the functional interface. The interface usage count is a total number of times the service-system functional block has used the functional interface.

The server is configured to use the access log created by the coordination control section to calculate an interface usage fee generated by the service-system functional block using the functional interface.

The service providing system of the present disclosure configured as described above can calculate the interface usage fee by using at least one of the interface usage count or the communication data amount included in the access log. Therefore, the service providing system of the present disclosure can charge a service provider who provides a service to the vehicle.

Another aspect of the present disclosure is a server including a communication section and a charging calculation section.

The communication section is configured to be capable of data communication with the vehicle control system. The charging calculation section is configured to use the access log to calculate an interface usage fee when the access log is received from the vehicle control system.

The server of the present disclosure configured as described above is a server included in the service providing system of the present disclosure, and can obtain an effect similar to that of the service providing system of the present disclosure.

Another aspect of the present disclosure is an on-vehicle device mounted on a vehicle and connected to a plurality of electronic control devices by an on-vehicle network, the on-vehicle device including a functional interface, an access log creation section, and a log transmission section.

The access log creation section is configured to create an access log including at least one of an interface usage count and an amount of communication data based on an execution status of access requests by the plurality of electronic control devices. The log transmission section is configured to transmit the access log to a server installed outside the on-vehicle device.

The on-vehicle device of the present disclosure configured as described above is a device included in the service providing system of the present disclosure, and can obtain an effect similar to that of the service providing system of the present disclosure.

Another aspect of the present disclosure is a service providing method executed by a service providing system comprising a vehicle control system and a server. The vehicle control system includes a coordination control section configured to implement coordination between a service-system functional block and a functional block, the functional block including a functional interface. In the service providing method of the present disclosure, the coordination control section transfers an access request transmitted from the service-system functional block to the functional block. The coordination control section also creates an access log including at least one of an interface usage count and an amount of communication data based on an execution status of the access request by a plurality of electronic control devices. The server uses the access log created by the coordination control section to calculate an interface usage fee generated by the service-system functional block using the functional interface.

The service providing method of the present disclosure is a method executed by the service providing system of the present disclosure, and by executing the method, it is possible to obtain an effect similar to that of the service providing system of the present disclosure.

Another aspect of the present disclosure is a service providing program for causing a computer to function as a communication section and a charging calculation section.

A computer controlled by the service providing program of the present disclosure can constitute a part of the server of the present disclosure, and can obtain an effect similar to that of the server of the present disclosure.

Another aspect of the present disclosure is a service providing method executed by a server of a service providing system comprising a vehicle control system including a functional interface and a server configured to be capable of data communication with the vehicle control system. In the service providing method of the present disclosure, the server performs data communication with the vehicle control system. When the server receives an access log created based on an execution status of an access request by a plurality of electronic control devices, the access log including at least one of an interface usage count and an amount of communication data, the server uses the access log to calculate an interface usage fee generated by the service-system functional block using the functional interface.

The service providing method of the present disclosure is a method executed by the server of the present disclosure, and by executing the method, it is possible to obtain an effect similar to that of the server of the present disclosure.

Another aspect of the present disclosure is a service providing program for causing a computer of an on-vehicle device, mounted on a vehicle and connected to a plurality of electronic control devices by an on-vehicle network, to function as a functional interface, an access log creation section, and a log transmission section.

A computer controlled by the service providing program of the present disclosure can constitute a part of the on-vehicle device of the present disclosure, and can obtain effect similar to that of the on-vehicle device of the present disclosure.

Another aspect of the present disclosure is a service providing method executed by an on-vehicle device mounted on a vehicle and connected to a plurality of electronic control devices by an on-vehicle network. The on-vehicle device includes a functional interface. In the service providing method of the present disclosure, the on-vehicle device creates an access log including at least one of an interface usage count and an amount of communication data, based on an execution status of access requests by the plurality of electronic control devices. The on-vehicle device also transmits the access log to a server installed outside the on-vehicle device.

The service providing method of the present disclosure is a method executed by the on-vehicle device of the present disclosure, and by executing the method, a similar effect to those of the server of the present disclosure can be obtained.

### First Embodiment

Hereinafter, a first embodiment of the present disclosure will be described with reference to the drawings.

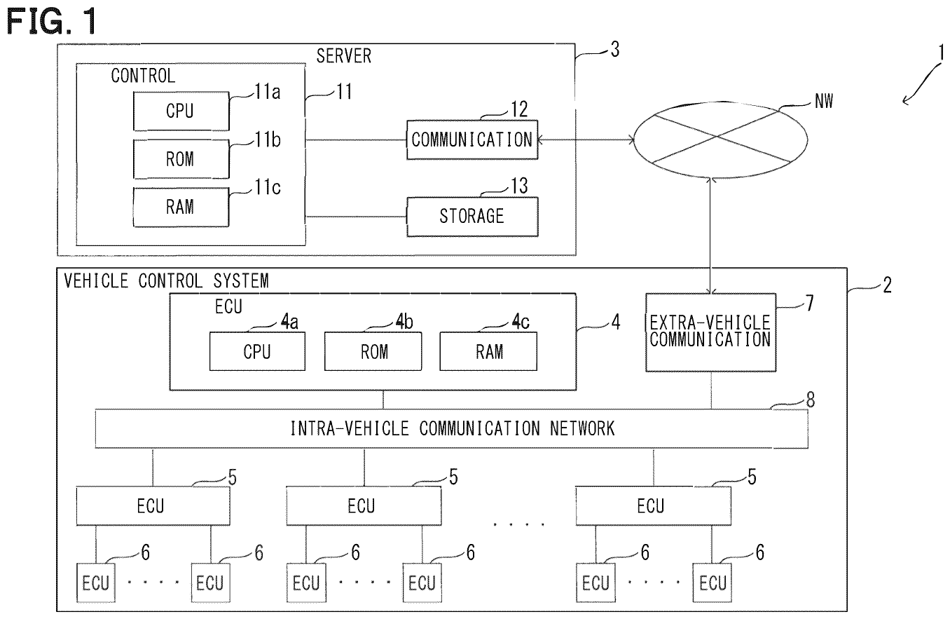

As illustrated in FIG. 1, a service providing system 1 of the present embodiment includes a vehicle control system 2 and a server 3.

The vehicle control system 2 is mounted on a vehicle and has a function of performing data communication with the server 3 via a wide-area wireless communication network NW.

The server 3 has a function of performing data communication with the vehicle control system 2 via the wide-area wireless communication network NW. In the server 3, an application store accessible via the wide-area wireless communication network NW or the Internet is installed.

The vehicle in which the vehicle control system 2 is mounted may have an automated driving function in addition to a manual driving function. The vehicle may be a hybrid vehicle with an engine and an electric motor as the drive source for travel. The vehicle is not limited to a vehicle with an automated driving function and a hybrid vehicle, and may be a vehicle with only a manual driving function, or may be a vehicle with only an engine or only an electric motor as the drive source for travel. Hereinafter, the vehicle in which the vehicle control system 2 is mounted is simply referred to as the vehicle.

The vehicle control system 2 includes one ECU 4, a plurality of ECUs 5, a plurality of ECUs 6, an extra-vehicle communication device 7, and an intra-vehicle communication network 8. ECU stands for an electronic control device.

The ECU 4 unifies the plurality of ECUs 5 to implement coordinated control of the entire vehicle.

The ECU 5 is provided for each domain divided according to functions in the vehicle and mainly executes the control of the plurality of ECUs 6 existing in the domain. Each ECU 5 is connected to its subordinate ECU 6 via a lower-level network (e.g., CAN) provided individually. CAN stands for Controller Area Network. CAN is a registered trademark. The domain is, for example, a powertrain, a body, a chassis, a cockpit, or the like.

The ECUs 6 connected to the ECU 5 belonging to the powertrain domain include, for example, an ECU 6 that controls the engine, an ECU 6 that controls the motor, an ECU 6 that controls the battery, and the like.

The ECU 6 connected to the ECU 5 belonging to the body domain includes, for example, an ECU 6 that controls the air conditioner, an ECU 6 that controls the doors, and the like.

The ECU 6 connected to the ECU 5 belonging to the chassis domain includes, for example, the ECU 6 that controls the brake, the ECU 6 that controls the steering, and the like.

The ECU 6 connected to the ECU 5 belonging to the cockpit domain includes, for example, an ECU 6 that controls the meter and navigation display, an ECU 6 that controls the input device operated by a vehicle occupant, and the like.

The extra-vehicle communication device 7 performs data communication with the server 3 via the wide-area wireless communication network NW.

The intra-vehicle communication network 8 includes a CAN FD and Ethernet. Ethernet is a registered trademark. CAN FD stands for an abbreviation of CAN with Flexible Data Rate. The CAN FD connects the ECU 4, each ECU 5, and the extra-vehicle communication device 7 via a bus. The Ethernet individually connects the ECU 4, each ECU 5, and the extra-vehicle communication device 7.

The ECU 4 is an electronic control device mainly including a microcomputer provided with a central processing unit (CPU) 4a, a read-only memory (ROM) 4b, and random-access memory (RAM) 4c. Various functions of the microcomputer are each implemented by the CPU 4a executing a program stored in a non-transitory tangible recording medium. In this example, the ROM 4b corresponds to the non-transitory tangible recording medium storing a program. By executing the program, a method corresponding to the program is executed. Some or all of the functions executed by the CPU 4a may be configured as hardware by one or more integrated circuits (ICs) or the like. The number of microcomputers constituting the ECU 4 may be one or more.

Similarly to the ECU 4, each of the ECUs 5, the ECUs 6, and the extra-vehicle communication device 7 is an electronic control device mainly including a microcomputer provided with a CPU, a ROM, a RAM, and the like. In addition, the number of microcomputers constituting each of the ECUs 5, the ECUs 6, and the extra-vehicle communication device 7 may be one or more. The ECU 5 unifies one or more ECUs 6. The ECU 4 unifies one or more ECUs 5, or unifies the ECUs 5, 6 and the extra-vehicle communication device 7 of the entire vehicle.

Hereinafter, the ECUs 4, 5, 6 and the extra-vehicle communication device 7 will be referred to as on-vehicle devices 4 to 7 unless otherwise distinguished.

The server 3 includes a control section 11, a communication section 12, and a storage section 13.

The control section 11 is an electronic control device mainly including a microcomputer provided with a CPU 11a, a ROM 11b, a RAM 11c, and the like. Various functions of the microcomputer are implemented by the CPU 11a executing a program stored in a non-transitory tangible recording medium. In this example, the ROM 11b corresponds to the non-transitory tangible recording medium storing a program. By executing the program, a method corresponding to the program is executed. Some or all of the functions executed by the CPU 11a may be configured as hardware by one or a plurality of ICs or the like. The number of microcomputers constituting the control section 11 may be one or more.

The communication section 12 performs data communication with the vehicle control system 2 via the wide-area wireless communication network NW. The storage section 13 is a storage device for storing various data.

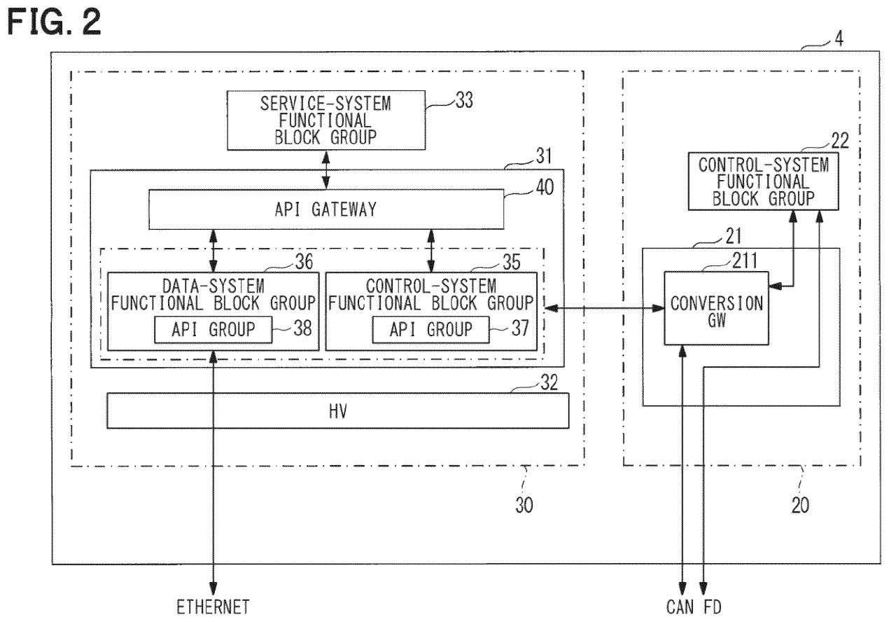

As illustrated in FIG. 2, the ECU 4 includes a real-time processing section 20 and an application processing section 30 (hereinafter, application processing section 30). When the ECU 4 includes a plurality of CPUs 4a, the real-time processing section 20 and the application processing section 30 may be implemented by processing executed by the same CPU, or may be implemented by processing executed by different CPUs, respectively.

The real-time processing section 20 coordinates with the on-vehicle devices 5 to 7 connected via the CAN FD to execute vehicle control and the like that require real-time performance. The application processing section 30 coordinates with the on-vehicle devices 5 to 7 connected via the Ethernet to execute various applications (e.g., an entertainment application, etc.) that require high processing capability.

The application processing section 30 has a function of transmitting instructions and the like based on processing of various applications to the real-time processing section 20. The real-time processing section 20 has a function of transmitting information or the like, collected from the ECU or the like via the CAN FD, to the application processing section 30. As a result, the real-time processing section 20 and the application processing section 30 coordinate with each other to implement various functions.

The software of the vehicle control system 2 is constructed according to AUTOSAR. AUTOSAR is an architecture for automated driving and stands for Automotive Open System Architecture. AUTOSAR is a registered trademark. AUTOSAR provides not only communication between software components (hereinafter, SW-Cs), mounted to implement various applications, but also functions related to connection to a cloud, security, and the like. The SW-C is componentized software for implementing a certain function. The application program includes one or more SW-Cs. The software of the vehicle control system 2 is not necessarily constructed according to AUTOSAR.

Each of the devices belonging to the vehicle control system 2, that is, each of the ECUs 4, 5, 6 and the extra-vehicle communication device 7, includes a platform. The platform provides an environment for executing an SW-C described in a hardware-independent format.

The platform includes a runtime environment (hereinafter, RTE) and base software (BSW). The RTE is an interface that connects between SW-Cs and between an SW-C and a BSW. The BSW is a hierarchy connecting the hardware and the SW-C, and includes an operating system (OS), a driver, middleware, and the like. The function of the BSW is divided into fine modules, and the function of each module is provided to the SW-C via an API. API stands for Application Programming Interface.

Hereinafter, platforms included in the real-time processing section 20 are referred to as a first platform 21 (hereinafter, first PF 21), and the platform included in the application processing section 30 is referred to as a second platform 31 (hereinafter, second PF 31).

The real-time processing section 20 includes a control-system functional block group 22 as a set of service applications (hereinafter, service application) operating on the first PF 21. The service application is an application that receives a request from a client, processes the request, and returns a result.

The control-system functional block group 22 includes an API for receiving a command related to the motion of the vehicle, and is an application group for unifying the commands received by the API to implement well-coordinated vehicle control. The control-system functional block group 22 outputs various commands to the on-vehicle devices 5 to 7, in which entities that execute control based on the commands exist, via the intra-vehicle communication network 8.

The first PF 21 includes a conversion gateway 211. The conversion gateway 211 has a function of converting a communication frame, received by the real-time processing section 20 via the CAN FD, into an Ethernet format and providing the converted communication frame to the application processing section 30. In addition, the conversion gateway 211 has a function of converting the communication frame in the Ethernet format, provided from the application processing section 30, into a CAN FD format.

The application processing section 30 includes a hypervisor 32 and executes software on a plurality of virtual machines. The hypervisor 32 may be omitted.

The application processing section 30 includes a service-system functional block group 33 as a set of service applications that operate on the second PF 31.

The service-system functional block group 33 is a set of service applications. Each service application includes one or more SW-Cs. The service application is provided not only by the vehicle manufacturer that manufactured the vehicle but also by a third party. Examples of the third party that provides the service application include a data utilization company that provides a service by collecting data from a vehicle.

The second PF 31 includes a control-system functional block group 35, a data-system functional block group 36, and an API gateway 40.

The control-system functional block group 35 is a set of programs including an API for receiving a request related to vehicle control from the service-system functional block group 33. The control-system functional block group 35 includes an API group 37 formed of a plurality of APIs. The control-system functional block group 35 converts an API access request from the service-system functional block group 33, expressed in a vehicle-independent format, into an API access request expressed in a vehicle-dependent format, and provides the converted request to the real-time processing section 20. The “vehicle-independent format” is a format common to vehicles (i.e., a format that absorbs differences among vehicle types). The “vehicle-dependent format” is a format specific to a vehicle.

The APIs provided by the control-system functional block group 35 include a motion-system API that controls the motion of the vehicle and other non-motion-system APIs. The API access request received by the motion-system API is transferred to the control-system functional block group 35, and transferred from the control-system functional block group 35 to the on-vehicle devices 5 to 7 that execute control based on the request via the intra-vehicle communication network 8. The API access request received by the non-motion-system API is transferred to the on-vehicle devices 5 to 7 that execute control based on the request via the intra-vehicle communication network 8.

The data-system functional block group 36 is a set of programs including an API for handling vehicle data acquired and accumulated via the real-time processing section 20. The data-system functional block group 36 has a function of abstracting and accumulating vehicle data, expressed in a vehicle-dependent format and supplied from the real-time processing section 20, in a vehicle-independent format. The data-system functional block group 36 may include an API that provides a function of transmitting designated vehicle data to the ECU or the like via Ethernet. In particular, when the destination is the extra-vehicle communication device 7, the extra-vehicle communication device 7 may upload the transmitted vehicle data to the cloud. Similarly to the control-system functional block group 35, the data-system functional block group 36 includes an API group 38 including a plurality of APIs.

The communication with other on-vehicle devices 5 to 7 via the control-system functional block group 35 is not limited to the CAN FD, and the Ethernet or other communication means may be used. In addition, the communication with other on-vehicle devices 5 to 7 via the data-system functional block group 36 is not limited to the Ethernet, and the CAN FD or other communication means may be used.

The API gateway 40 is configured using a function of a virtual function bus (hereinafter, VFB). The VFB is middleware that enables SW-C communication and SW-C and BSW communication to be implemented without being conscious of hardware, a communication protocol, and the like, and is also referred to as a software bus. The SW-C communication is an access from the SW-C to an API provided by another SW-C, and the SW-C and BSW communication is an access from the SW-C to an API provided by each of the control-system functional block group 35 and the data-system functional block group 36.

That is, the SW-C accesses various APIs via the API gateway 40, and implements a desired function using a function provided by the accessed API.

The SW-C transmits an API access request when using the API. The API access request includes at least an application ID of a service application that includes the SW-C as a requester, and an API-ID that is information indicating an API as a request target.

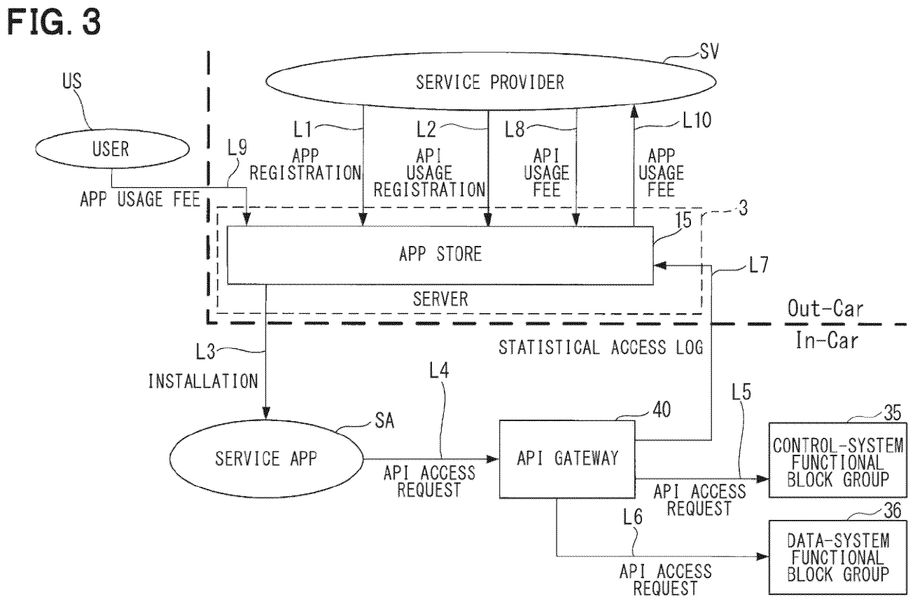

As illustrated in FIG. 3, an application store 15 is installed in the server 3. As indicated by an arrow L1, the application store 15 has a function of registering a service application SA manufactured by a service provider SV in the application store 15, based on submission by the service provider SV who accessed the application store 15 using a communication device such as a personal computer. The service application SA registered in the application store 15 is posted on the website of the application store 15.

Further, as indicated by an arrow L2, the application store 15 has a function of registering the API used by the service application SA in the application store 15, based on submission by the service provider SV.

When a user US who has accessed the website of the application store 15 purchases the service application SA, the service application SA is installed in the ECU 4 mounted on the vehicle of the user US, as indicated by an arrow L3.

When the service application SA transmits the API access request to the API gateway 40, as indicated by an arrow L4, the API gateway 40 transfers the API access request to the control-system functional block group 35, as indicated by an arrow L5. As described above, the control-system functional block group 35 converts the API access request into an API access request expressed in a vehicle-dependent format and provides the API access request to the real-time processing section 20. Further, as indicated by an arrow L6, the API gateway 40 transfers the API access request to the data-system functional block group 36. The data-system functional block group 36 converts the API access request into an API access request expressed in a vehicle-dependent format, and transmits the API access request to the ECU or the like via the Ethernet.

As indicated by an arrow L7, the API gateway 40 transmits, to the application store 15, a statistical access log including the API usage count, calculated in consideration of the execution accomplishment status of the API access requests, and the communication data amount associated with API usage.

The application store 15 calculates an API usage fee generated by the service application SA using the API, based on the statistical access log received from the API gateway 40, and charges the service provider SV for the API usage fee. The service provider SV pays the charged API usage fee to the application store 15, as indicated by arrow L8.

The application store 15 calculates an application usage fee of the service application SA based on the usage status of the service application SA, and charges the user US for the application usage fee. The user US pays the charged application usage fee to the application store 15, as indicated by an arrow L9. As indicated by an arrow L10, the application store 15 transfers the application usage fee paid by the user US to the service provider SV.

Next, a procedure when the service provider SV makes an API usage contract will be described.

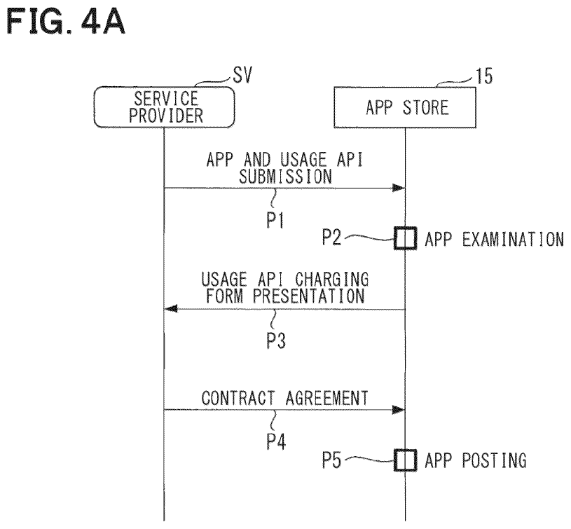

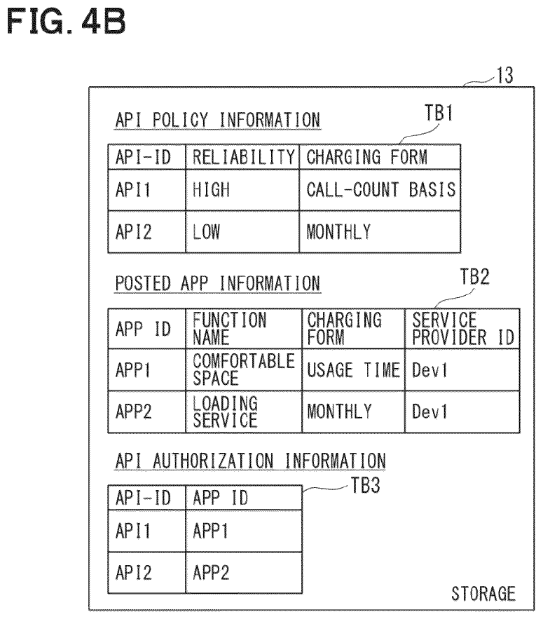

As illustrated in process P1 of FIG. 4A, the service provider SV accesses the application store 15 and submits the registration of a service application to be posted and an API to be used.

As indicated by process P2, the application store 15 examines whether the service application submitted by the service provider SV can access the control-system functional block group 35.

When the submitted service application can access the control-system functional block group 35, the application store 15 presents the usage API charging form to the service provider SV, as indicated in process P3.

As illustrated in Table TB1 in FIG. 4B, the application store 15 stores API policy information including an API-ID, reliability, and a charging form for each submitted API in the storage section 13.

In Table TB1, the reliability of the API with API-ID of API1 is “high”, the charging form is “call-count basis”, the reliability of the API with API-ID of API2 is “low”, and the charging form is “monthly”.

The API with the reliability set to “high” accepts an API access request from a service application with higher reliability and rejects an API access request from a service application with lower reliability.

The API with the reliability set to “low” accepts an API access request even from a service application with low reliability.

The “call-count basis” refers to a charging form in which a fee is added according to the number of times of API access requests. The “monthly” refers to a charging form in which a fixed fee independent of the number of times of API access requests is charged every month.

As illustrated in process P4, the service provider SV notifies the application store 15 that the service provider SV agrees to the contract on the presented usage API charging form. As a result, the application store 15 posts the service application submitted by the service provider SV on the website of the application store 15, as illustrated in process P5.

The application store 15 stores, in the storage section 13, information on the service application posted on the website (hereinafter, posted application information) and information on an API authorized for the service application posted on the website (hereinafter, API authorization information).

As illustrated in Table TB2 in FIG. 4B, the posted application information includes, for each posted service application, an application ID, the function name of the service application, a charging form of the service application, and a service provider ID. The application ID is information for identifying a service application. The service provider ID is information for identifying a provider of the service application.

In Table TB2, the function name of the service application with application ID of APP1 is “comfort air conditioning”, the charging form is “usage time”, and the service provider ID is “Dev1”. The function name of the service application with application ID of APP2 is “loading service”, the charging form is “monthly”, and the service provider ID is “Dev1”.

The “usage time” charging form is a charging form in which a charge is added according to the usage time of the service application. The “monthly fee” of the charging form is a charging form in which a fixed fee independent of the usage time of the service application is charged every month.

As illustrated in Table TB3 in FIG. 4B, the API authorization information includes the API-ID and the application ID for each API authorized to be used.

Table TB3 indicates that the API with API-ID of API1 is called by the service application with application ID of APP1, and the API with API-ID of API2 is called by the service application with application ID of APP2.

Next, a procedure for a log creation process executed by the API gateway 40 will be described. The log creation process is a process repeatedly executed during the operation of the ECU 4.

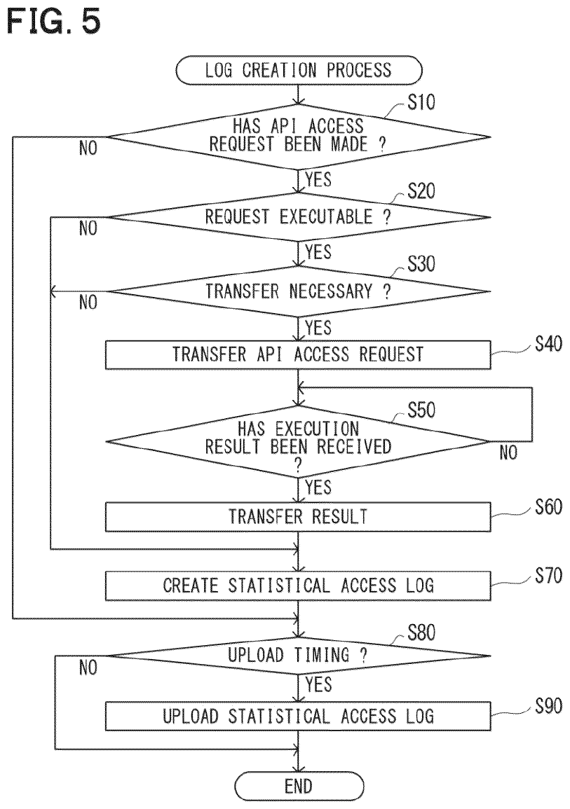

When the log creation process is executed, as illustrated in FIG. 5, the API gateway 40 (hereinafter, API GW 40) first determines whether an API access request has been received in S10. Here, when the API access request has not been received, the API GW 40 proceeds to S80. On the other hand, when the API access request is received, the API GW 40 determines whether the received API access request can be executed in S20. For example, the API GW 40 determines whether the ECU 4 can perform data communication with the ECU 6 that executes the process instructed by the API access request. When data communication is possible, the API GW 40 determines that the API access request is executable, and when data communication is not possible, API GW determines that the API access request is not executable.

Here, when the API access request is not executable, the API GW 40 proceeds to S70. On the other hand, when the API access request is executable, the API GW 40 determines whether the received API access request needs to be transmitted to the API as the request target in S30. For example, when the process instructed by the API access request has already been executed, the API GW 40 determines that the API access request does not need to be transferred to the API as the request target.

Here, when the API access request does not need to be transferred, the API GW 40 proceeds to S70. On the other hand, when the API access request needs to be transferred, the API GW 40 transfers the received API access request to the API as the request target in S40.

Then, in S50, the API GW 40 determines whether an execution result of the transferred API access request has been received from the API that has transferred the API access request. Here, when the execution result has not been received, the process of S50 is repeated to wait until the execution result is received.

When the execution result of the API access request is received, the API GW 40 transfers the execution result received from the API to the service application as the requester of the API access request in S60, and the process proceeds to S70.

When the process proceeds to S70, the API GW 40 creates a statistical access log.

The statistical access log is specified by an application providing an API, an API, and a requester of an API access request. That is, when the number of applications providing APIs is A, the number of APIs is B, and the number of requesters of API access requests is C, the number of statistical access logs is A×B×C.

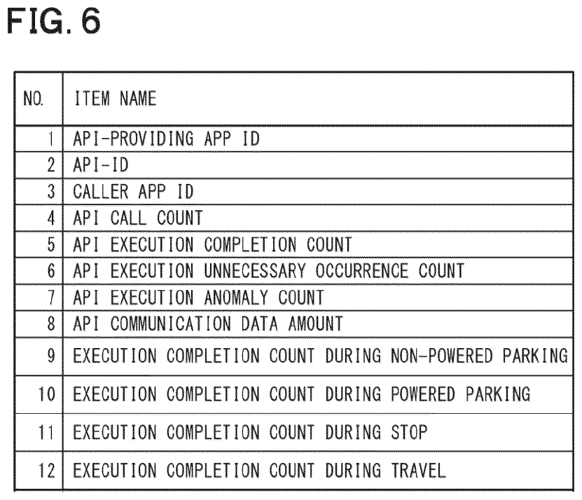

As illustrated in FIG. 6, a statistical access log includes the following data: an API-providing application ID, an API-ID, a caller application ID, an API call count, an API execution completion count, an API execution unnecessary occurrence count, an API execution anomaly count, an API communication data amount, an execution completion count during non-powered parking, an execution completion count during powered parking, an execution completion count during stop, and an execution completion count during travel.

The API-providing application ID is the identifier of the application providing the API. The API-ID is the identifier of the API. The caller application ID is the identifier of the application using the API.

The API call count is the number of times the service application specified by the caller application ID made an API access request.

The API execution completion count is the number of times the process in response to the API access request was executed and completed.

The API execution unnecessary occurrence count is the number of times the execution of the process in response to the API access request became unnecessary because the process had already been executed.

The API execution anomaly count is the number of times the process in response to the API access request was not executed due to an anomaly.

The API communication data amount is an integrated value of the amount of data acquired by the process in response to the API access request.

The execution completion count during non-powered parking is the number of times the process in response to the API access request was executed and completed during non-powered parking.

The execution completion count during the powered parking is the number of times the process in response to the API access request was executed and completed during the powered parking.

The execution completion count during stop is the number of times the process in response to the API access request was executed and completed while the vehicle is stopped.

The execution completion count during travel is the number of times that the process in response to the API access request was executed and completed while the vehicle is traveling.

Note that classifying the execution completion count into “during non-powered parking”, “during powered parking”, “during stop”, and “during travel” is an example, and the number of execution completion count in other vehicle states may be added.

Next, a first specific example of statistical access log creation will be described.

It is assumed that the door of the vehicle during non-powered parking is in an unlocked state, and the service application transmits an API access request instructing door locking to the API GW 40. Upon receiving the API access request, the API GW 40 checks the status of the vehicle door. Because the vehicle door is in the unlocked state, the API GW 40 determines that the API access request needs to be transferred, and transfers the received API access request to the request-targeted API. Accordingly, the ECU 4 transmits a command for instructing door locking to the ECU 6 that controls the door. Upon receiving the command for instructing door locking, the ECU 6 that controls the door locks the vehicle door. When the vehicle door is completely locked, the ECU 6 that controls the door transmits an execution result indicating that the vehicle door is now locked to the ECU 4. Upon receiving the execution result from the request-targeted API, the API GW 40 transfers the execution result to the requester service application. Moreover, the API GW 40 increments (i.e., adds 1 to) the API call count and the API execution completion count in the statistical access log specified by the API-providing application ID, the API-ID, and the caller application ID, and increments the execution completion count during non-powered parking.

Next, a second specific example of statistical access log creation will be described.

It is assumed that the door of the vehicle during powered parking is in a locked state, and the service application transmits an API access request instructing door locking to the API GW 40. Upon receiving the API access request, the API GW 40 checks the status of the vehicle door. Since the vehicle door is in the locked state, the API GW 40 determines that the transfer of the API access request is unnecessary, and transmits a notification to the requester service application, indicating that the door locking instruction has been normally completed. Further, the API GW 40 increments the API call count and the API execution unnecessary occurrence count in the statistical access log.

Next, a third specific example of statistical access log creation will be described.

It is assumed that the door of the vehicle during non-powered parking is in the unlocked state, a first service application transmits an API access request instructing door locking to the API GW 40, and a second service application transmits an API access request instructing door unlocking to the API GW 40. The API GW 40 arbitrates between the first service application and the second service application. Since the second service application has a higher priority than the first service application, the API GW 40 transmits a notification indicating that the door locking instruction has not been executed due to arbitration failure to the first service application, and increments the API call count and the API execution anomaly count in the statistical access log of the first service application. In addition, since the vehicle door is in the unlocked state, the API GW 40 determines that the transfer of the API access request of the second service application is unnecessary, and transmits a notification to the second service application, indicating that the door unlocking instruction has been normally completed. Further, the API GW 40 increments the API call count and the API execution unnecessary occurrence count in the statistical access log of the second service application.

Next, a fourth specific example of statistical access log creation will be described.

It is assumed that the service application transmits an API access request for instructing acquisition of vehicle speed information to the API GW 40 while communication between the ECU 4 and the on-vehicle devices 5 to 7 is interrupted. Since communication is anomalous, the API GW 40 transmits a notification to the requester service application, indicating that the vehicle speed information cannot be acquired due to the communication anomaly. Moreover, the API GW 40 increments the API call count and the API execution anomaly count in the statistical access log specified by the API-providing application ID, the API-ID, and the caller application ID.

Next, a fifth specific example of statistical access log creation will be described.

It is assumed that the service application transmits an API access request instructing acquisition of vehicle speed information that is updated every 300 ms to the API GW 40. Since 300 ms or more has elapsed from the previous API access request instructing acquisition of vehicle speed information, the API GW 40 determines that transfer of the API access request is necessary, and transfers the received API access request to the request-targeted API. Accordingly, the ECU 4 transmits a command for instructing acquisition of vehicle speed information to the ECU 6 that controls the engine. Upon acquiring the vehicle speed information, the ECU 6 that controls the engine transmits an execution result indicating the acquired vehicle speed information to the ECU 4. Upon receiving the execution result from the request-targeted API, the API GW 40 transfers the execution result to the requester service application. Further, the API GW 40 increments the API call count and the API execution completion count in the statistical access log specified by the API-providing application ID, the API-ID, and the caller application ID.

Moreover, it is assumed that after 100 ms elapses from the previous API access request instructing acquisition of vehicle speed information, the service application transmits an API access request instructing acquisition of vehicle speed information to the API GW 40. Since 300 ms or more has not elapsed from the previous API access request, the API GW 40 determines that the transfer of the API access request is unnecessary, transmits the vehicle speed information having the same value as the previous value to the requester service application, and increments the API call count and the API execution unnecessary occurrence count in the statistical access log.

Next, a sixth specific example of statistical access log creation will be described.

It is assumed that the service application transmits an API access request instructing acquisition of surrounding map data to the API GW 40. The API GW 40 determines that the API access request needs to be transferred, and transfers the received API access request to the request-targeted API. As a result, the ECU 4 transmits a command for instructing acquisition of surrounding map data to the ECU 6 that controls the navigation device. Upon acquiring the surrounding map data, the ECU 6 that controls the navigation device transmits an execution result indicating the acquired surrounding map data to the ECU 4. Upon receiving the execution result from the request-targeted API, the API GW 40 transfers the execution result to the requester service application. Moreover, the API GW 40 increments the API call count and the API execution completion count in the statistical access log specified by the API-providing application ID, the API-ID, and the caller application ID, and adds a value corresponding to the surrounding map data amount to the API communication data amount.

As illustrated in FIG. 5, when the process of S70 ends, the API GW 40 determines whether the upload timing has arrived in S80. The upload timing is set to arrive every 24 hours, for example.

Here, when the upload timing has not arrived, the API GW 40 ends the log creation process. On the other hand, when the upload timing arrives, the API GW 40 uploads all the statistical access logs to the server 3 in S90, and ends the log creation process.

Next, procedures for user settlement and service provider settlement will be described.

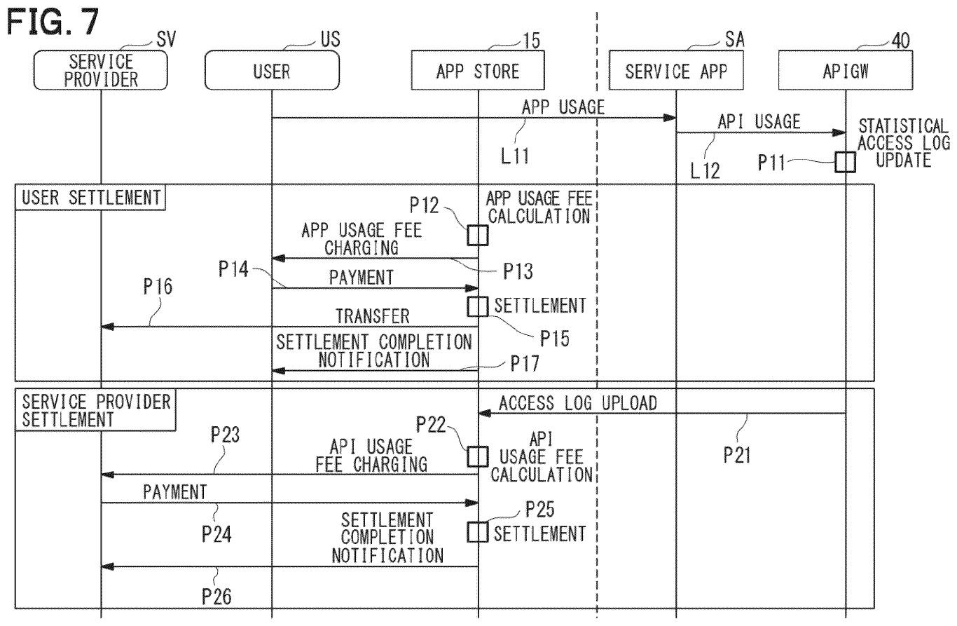

The user US uses the service application SA, as indicated by an arrow L11 in FIG. 7, and the service application SA uses the API, as indicated by an arrow L12. Each time the service application SA uses the API, the API GW 40 updates the statistical access log, as indicated in process P11.

As illustrated in process P12, the application store 15 calculates an application usage fee generated by the user US using the service application SA every month, for example, and charges the user US for the calculated application usage fee, as illustrated in process P13.

As illustrated in process P14, when the user US pays the application usage fee to the application store 15, the application store 15 settles the application usage fee, as illustrated in process P15. Thereafter, the application store 15 transfers the application usage fee to the service provider SV, as illustrated in process P16, and notifies the user US of the completion of the settlement, as illustrated in process P17.

As indicated in process P21, when the API GW 40 uploads the statistical access log, the application store 15 calculates the API usage fee generated by the service application SA using the API, based on the statistical access log, as indicated in process P22.

For each statistical access log specified by the API-providing application ID, the API-ID, and the caller application ID, the application store 15 sets an execution completion charging coefficient C1, an execution unnecessary charging coefficient C2, an execution anomaly charging coefficient C3, a communication data charging coefficient C4, an execution completion charging coefficient C5 during non-powered parking, an execution completion charging coefficient C6 during powered parking, an execution completion charging coefficient C7 during stop, and an execution completion charging coefficient C8 during travel.

The execution completion charging coefficient C1 is the amount charged when the API execution completion count is 1.

The execution unnecessary charging coefficient C2 is the amount charged when the API execution unnecessary occurrence count is 1.

The execution anomaly charging coefficient C3 is the amount charged when the API execution anomaly count is 1.

The communication data charging coefficient C4 is the amount charged per unit communication data amount.

The execution completion charging coefficient C5 during non-powered parking is the amount charged when the execution completion count during non-powered parking is 1.

The execution completion charging coefficient C6 during powered parking is the amount charged when the execution completion count during powered parking is 1.

The execution completion charging coefficient C7 during stop is the amount charged when the execution completion count during stop is 1.

The execution completion charging coefficient C8 during travel is the amount charged when the execution completion count during travel is 1.

That is, the application store 15 calculates the API usage fee by multiplying the number of times or the data amount by the corresponding coefficient per statistical access log. Further, the application store 15 calculates the API usage fee of the service application SA by integrating the API usage fee of all the statistical access logs.

When there are a plurality of APIs that operate the same actuator and the plurality of APIs have different arbitration priorities, the charging coefficient of the API with a high priority is greater than the charging coefficient of the API with a low priority.

The execution completion charging coefficient C5 during non-powered parking is greater than the execution completion charging coefficient C6 during powered parking. That is, the charged amount is greater during non-powered parking with limited power than during powered parking with power supply.

In addition, the execution completion charging coefficient C7 during stop is greater than the execution completion charging coefficient C8 during travel. That is, the charged amount is greater during stop with limited power than during travel with power generation.

In addition, when there are a plurality of APIs that acquire the same information and the plurality of API have different responsiveness, the charging coefficient of the API with higher responsiveness is greater than the charging coefficient of the API with lower responsiveness.

In addition, the charging coefficient varies depending on the quality of the acquired data. For example, data that requires know-how, such as narrow-road scene determination, has a large charging coefficient, and simple data, such as vehicle speed information, has a small charging coefficient. The availability of equipment (e.g., Capability update notification) is free at the time of initial installation, and a change notification is charged. In addition, a charging coefficient of an API that simultaneously acquires a plurality of pieces of data, such as time-stamped data, is large.

When the calculation of the API usage fee of the service application SA is completed, the application store 15 charges the service provider SV with the calculated API usage fee, as illustrated in process P23.

As illustrated in process P24, when the service provider SV pays the API usage fee to the application store 15, the application store 15 settles the API usage fee, as illustrated in process P25. Thereafter, the application store 15 notifies the service provider SV of the completion of the settlement, as indicated in process P26.

The service providing system 1 as described above includes the vehicle control system 2 and the server 3.

The vehicle control system 2 is mounted on a vehicle. The vehicle control system 2 includes the on-vehicle devices 4 to 7 connected to the intra-vehicle communication network 8. The server 3 is configured to be capable of data communication with the vehicle control system 2.

The vehicle control system 2 includes the API gateway 40. The API gateway 40 is configured to implement coordination between the service-system functional block group 33, configured to provide a service to the vehicle equipped with the ECU 4, and the control-system functional block group 35, configured to control the vehicle.

The control-system functional block group 35 includes the API group 37. The API group 37 is configured to convert an API access request, expressed in a vehicle-independent format and transmitted from the service-system functional block group 33, into a vehicle-dependent format.

The API gateway 40 is configured to transfer the API access request transmitted from the service-system functional block group 33 to the control-system functional block group 35.

The API gateway 40 is configured to create a statistical access log based on the execution status of the API access request by each of the on-vehicle devices 4 to 7. The statistical access log includes the following data: an API call count, an API execution completion count, an API execution unnecessary occurrence count, an API execution anomaly count, an API communication data amount, an execution completion count during non-powered parking, an execution completion count during powered parking, an execution completion count during stop, and an execution completion count during travel.

The server 3 is configured to calculate an API usage fee generated by the service-system functional block group 33 using the API group 37 by using the statistical access log created by the API gateway 40.

Such a service providing system 1 can calculate the API usage fee by using the number of times and the communication data amount included in the statistical access log. Therefore, the service providing system 1 can charge the service provider SV who provides a service to the vehicle.

The server 3 includes the communication section 12 and the application store 15.

The communication section 12 is configured to be capable of data communication with the vehicle control system 2. The application store 15 is configured to calculate the API usage fee by using the statistical access log when receiving the statistical access log from the vehicle control system 2. Such a server 3 is a server included in the service providing system 1, and can obtain an effect similar to that of the service providing system 1.

The ECU 4 is mounted on the vehicle and is connected to the on-vehicle devices 5 to 7 by the intra-vehicle communication network 8. The ECU 4 includes the API group 37 and the API GW 40.

The API gateway 40 is configured to create a statistical access log based on the execution status of the API access request by each of the on-vehicle devices 4 to 7. The API gateway 40 is configured to transmit the statistical access log to the server 3 installed outside the ECU 4. Such an ECU 4 is a device included in the service providing system 1, and can obtain an effect similar to that of the service providing system 1.

In the embodiment described above, the intra-vehicle communication network 8 corresponds to an on-vehicle network, the on-vehicle device 4 to 7 correspond to the plurality of electronic control devices, the service-system functional block group 33 corresponds to a service-system functional block, the control-system functional block group 35 corresponds to a control-system functional block, and the API gateway 40 corresponds to a coordination control section.

The API group 37 corresponds to a functional interface, S40 corresponds to a process as a request transfer section, the API access request corresponds to an access request, S70 corresponds to a process as an access log creation section, and the statistical access log corresponds to an access log.

The API call count, the API execution completion count, the API execution unnecessary occurrence count, the API execution anomaly count, the execution completion count during non-powered parking, the execution completion count during powered parking, the execution completion count during stop, and the execution completion count during travel correspond to an interface usage count.

The API communication data amount corresponds to the communication data amount, and the API usage fee is an interface usage fee.

The API execution completion count corresponds to an execution completion count, the API execution unnecessary occurrence count corresponds to an execution unnecessary occurrence count, and the API execution anomaly count corresponds to an execution anomaly count.

The non-powered parking during non-powered parking, the execution completion count during powered parking, the execution completion count during stop, and the execution completion count during travel correspond to the number of times of completion in each of a plurality of vehicle states.

The API communication data amount corresponds to an integrated value of the data amount acquired by the service-system functional block, the application store 15 corresponds to a charging calculation section, and S90 corresponds to a process as a log transmission section.

### Second Embodiment

Hereinafter, a second embodiment of the present disclosure will be described with reference to the drawings. In the second embodiment, parts different from the first embodiment will be described. Common configurations are denoted by the same reference numerals.

The service providing system 1 of the second embodiment differs from that of the first embodiment in that statistical access log and the log creation process are changed.

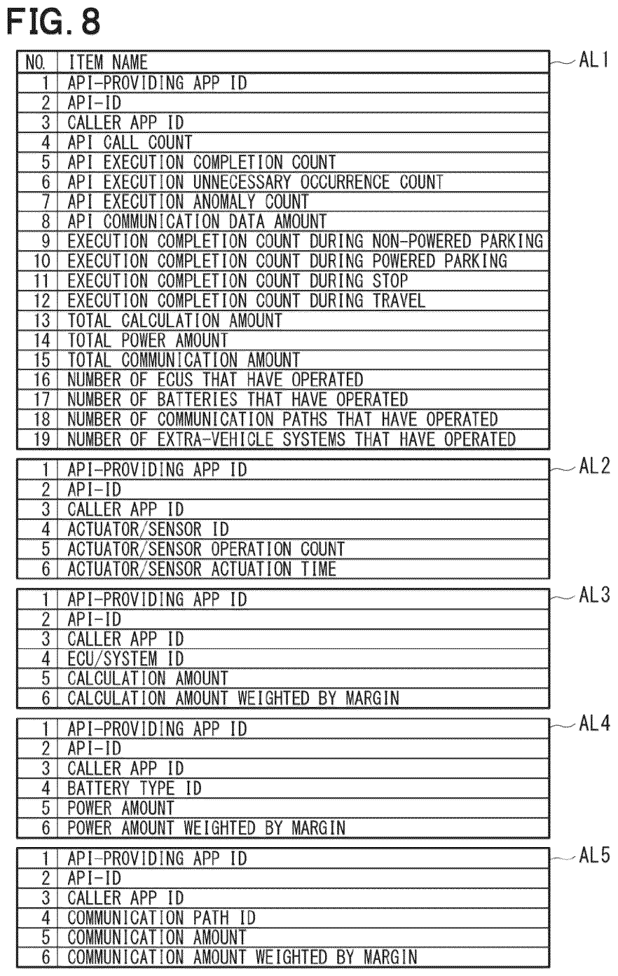

As illustrated in FIG. 8, the statistical access log of the second embodiment includes a plurality of first statistical access logs AL1, a plurality of second statistical access logs AL2, a plurality of third statistical access logs AL3, a plurality of fourth statistical access logs AL4, and a plurality of fifth statistical access log AL5.

The first statistical access log AL1 is specified by an application providing an API, an API, and a requester of an API access request.

The first statistical access log AL1 includes a total calculation amount, a total power amount, a total communication amount, the number of ECUs that have operated, the number of batteries that have operated, the number of communication paths, and the number of extra-vehicle systems that have operated, in addition to an API-providing application ID, an API-ID, a caller application ID, an API call count, an API execution completion count, an API execution unnecessary occurrence count, an API execution anomaly count, an API communication data amount, an execution completion count during non-powered parking, an execution completion count during powered parking, an execution completion count during stop, and an execution completion count during travel, as described above.

The total calculation amount is the total calculation amount required to provide the function of the API.

The total power amount is the total power amount required to provide the function of the API.

The total communication amount is the total communication amount required to provide the function of the API.

The number of ECUs that have operated is the number of ECUs that have cooperatively operated to provide the function of the API.

The number of batteries that have operated is the number of batteries used to provide the function of the API.

The number of communication paths that have operated is the number of communication paths used to provide the function of the API.

The number of extra-vehicle systems that have operated is the number of systems outside the vehicle cooperatively operated to provide the function of the API.

The first statistical access log AL1 is specified by an application providing an API, an API, and a requester of an API access request. That is, when the number of applications providing APIs is A, the number of APIs is B, and the number of requesters of the API access requests is C, the number of first statistical access logs AL1 is A×B×C.

The second statistical access log AL2 includes an API-providing application ID, an API-ID, a caller application ID, an actuator/sensor ID, an actuator/sensor operation count, and an actuator/sensor actuation time.

The actuator/sensor ID is the identifier of the actuator or the sensor.

The actuator/sensor operation count is the number of times the actuator or sensor has operated for an API call.

The actuator/sensor actuation time is the time that the actuator or sensor that have operated for an API call.

The second statistical access log AL2 is specified by an application providing an API, an API, a requester of the API access request, and an actuator or a sensor. That is, when the number of applications providing APIs is A, the number of APIs is B, the number of requesters of the API access requests is C, and the number of actuators or sensors is D, the number of second statistical access logs AL2 is A×B×C×D.

The third statistical access log AL3 includes an API-providing application ID, an API-ID, a caller application ID, an ECU/system ID, a calculation amount, and a calculation amount weighted by a margin.

The ECU/system ID is the identifier of the ECU or the system.

The calculation amount is a calculation amount required to provide the function of the API.

The calculation amount weighted by the margin is a value calculated by weighting the calculation amount required to provide the function of the API by the margin of the calculation resource of each ECU or system that has operated.

The third statistical access log AL3 is specified by an application providing an API, an API, a requester of an API access request, and an ECU or system. That is, when the number of applications providing APIs is A, the number of APIs is B, the number of requesters of the API access requests is C, and the number of ECUs or systems is E, the number of third statistical access logs AL3 is A×B×C×E.

The fourth statistical access log AL4 includes an API-providing application ID, an API-ID, a caller application ID, a battery type ID, a power amount, and a power amount weighted by a margin.

The battery type ID is the identifier of the battery type.

The power amount is the power amount required to provide the function of the API.

The power amount weighted by the margin is a value calculated by weighting the power amount required to provide the function of the API by the margin of the power amount of the battery.

The fourth statistical access log AL4 is specified by an application providing an API, an API, a requester of an API access request, and a battery type. That is, when the number of applications providing APIs is A, the number of APIs is B, the number of requesters of the API access requests is C, and the number of battery types is F, the number of fourth statistical access logs AL4 is A×B×C×F.

The fifth statistical access log AL5 includes an API-providing application ID, an API-ID, a caller application ID, a communication path ID, a communication amount, and a communication amount weighted by a margin.

The communication path ID is the identifier of the communication path.

The communication amount is a communication amount required to provide the function of the API.

The communication amount weighted by the margin is a value calculated by weighting the communication amount required to provide the function of the API by the margin of the communication band.

The fifth statistical access log AL5 is specified by an application providing an API, an API, a requester of the API access request, and a communication path. That is, when the number of applications providing APIs is A, the number of APIs is B, the number of requesters of the API access requests is C, and the number of communication paths is G, the number of fifth statistical access logs AL5 is A×B×C×G.

Next, a description will be given of a specific example of recording the calculation amount required for operating the actuator in the process in response to the API access request to the API included in the control-system functional block group 35 (hereinafter, operation-system API).

It is assumed that the vehicle window is fully open, and an API access request instructing the full closing of the window causes the vehicle window to be fully closed.

A vehicle equipped with a window open/close actuator having a pinching detection function requires a larger calculation amount for window open/close control than a vehicle equipped with a window open/close actuator not having a pinching detection function. That is, the calculation amount required to execute the open/close control so that the vehicle window is switched from fully open to fully closed varies depending on the type of the window open/close actuator.

Therefore, in the vehicle equipped with the window open/close actuator having the pinching detection function, a basic amount of calculation (hereinafter, basic calculation amount) required to execute open/close control so that the vehicle window changes from fully open to fully closed is set to, for example, “10”. In the vehicle equipped with the window open/close actuator not having the pinching detection function, the basic calculation amount required to execute the open/close control so that the vehicle window changes from fully open to fully closed is set to, for example, “5”.

It is assumed that the vehicle window is fully open or half open (e.g., 50% open), and an API access request instructing the full closing of the window causes the vehicle window to be fully closed.

When the vehicle window is fully open, the calculation amount required for the open/close control of the window is larger than when the vehicle window is half open.

Therefore, the calculation amount recorded in the statistical access log (hereinafter, recorded calculation amount) when the vehicle window is moved from fully open to fully closed is, for example, the basic calculation amount of the window open/close actuator. The recorded calculation amount when the vehicle window is moved from half open to fully closed is, for example, a value obtained by multiplying the basic calculation amount of the window open/close actuator by 0.5 when the window is 50% open.

That is, the API GW 40 adds the calculated recorded calculation amount to the “total calculation amount” in the first statistical access log AL1 corresponding to the executed process, and adds the calculated recorded calculation amount to the “calculation amount” in the third statistical access log AL3 corresponding to the executed process.

Next, a description will be provided for a specific example of recording the type and number of actuators that have operated in the process in response to the API access request to the operation-system API.

It is assumed that four windows or one window in the vehicle are fully open, and an API access request instructing the full closing of the window causes all the windows in the vehicle to be fully closed.

When the four windows are fully open, it is recorded in the statistical access log that the number of actuators that have operated is four, and when one window is fully open, it is recorded in the statistical access log that the number of actuators that have operated is one.

The number of operations of the window open/close actuator having the pinching detection function and the number of operations of the window open/close actuator not having the pinching detection function are recorded in the statistical access log.

That is, the API GW 40 records the type and number of actuators that have operated in the “number of ECUs that have operated” in the first statistical access log AL1 corresponding to the executed process.

Next, a description will be given of a specific example of recording the type and number of ECUs or systems that have cooperated to operate the actuator in the process in response to the API access request to the operation-system API.

It is assumed that a service application is placed in the cloud, and the service application transmits an API access request instructing an arbitrary window operation to the API gateway 40. In this case, the cooperative operation of four ECUs 5 belonging to the domains of the cloud system, the extra-vehicle communication device 7, the ECU 4, and the body is recorded in the statistical access log.

It is assumed that a service application is placed in the ECU 4, and the service application transmits an API access request instructing an arbitrary window operation to the API gateway 40. In this case, the cooperative operation of two ECUs 5 belonging to the domains of the ECU 4 and the body is recorded in the statistical access log.

It is assumed that a service application is placed in the ECU 5 belonging to the domain of the body, and the service application transmits an API access request instructing an arbitrary window operation to the API gateway 40. In this case, the operation of one of the ECUs 5 belonging to the domain of the body is recorded in the statistical access log.

That is, the API GW 40 records the type and number of ECUs or systems that have cooperated to operate the actuator in the “number of ECUs that have operated” and the “number of extra-vehicle systems that have operated” in the first statistical access log AL1 corresponding to the executed process.

Next, a description will be provided for a specific example of recording power consumption for operating the actuator in the process in response to the API access request to the operation-system API.

Each time the execution of the process in response to the API access request is normally completed, the power consumption of the system, ECU, or actuator that has performed the operation related to the process is recorded in the statistical access log. When it is difficult to directly measure the power consumption, the power consumption is calculated based on a power amount table with a preset power amount per operation for each of the plurality of systems, the plurality of ECUs, or the plurality of actuators. The unit price of electric power varies depending on the difference in the driving system of the automobile. For example, a vehicle having only an electric motor as a traveling drive source has a lower unit power cost than a vehicle having only an engine as a traveling drive source.

That is, the API GW 40 adds the calculated power consumption to the “total power amount” in the first statistical access log AL1 corresponding to the executed process, and adds the calculated power consumption to the “power amount” in fourth statistical access log AL4 corresponding to the executed process.

Next, a description will be provided for a specific example of recording the communication amount required for operating the actuator in the process in response to the API access request to the operation-system API.

Each time the execution of the process in response to the API access request is normally completed, the communication amount of the system, ECU, or actuator that has performed the operation related to the process is recorded in the statistical access log. When it is difficult to directly measure the communication amount, the communication amount is calculated based on a communication amount table with a preset communication amount per operation for each of the plurality of systems, the plurality of ECUs, or the plurality of actuators. Note that the communication amount is recorded for each type of communication path. Examples of the type of the communication path include a satellite line, a mobile phone line, extra-vehicle Wi-Fi communication, in-vehicle Ethernet communication, in-vehicle CAN communication, and in-vehicle Wi-Fi communication. Note that, for example, the price weighting differs for each line, such as a satellite line and in-vehicle CAN communication with high communication cost have a high communication fee, and extra-vehicle Wi-Fi communication has a low communication fee. Wi-Fi is a registered trademark.

That is, the API GW 40 adds the calculated communication amount to the “total communication amount” in the first statistical access log AL1 corresponding to the executed process, and adds the calculated communication amount to the “communication amount” in the fifth statistical access log AL5 corresponding to the executed process.

The API GW 40 calculates a resource amount weighted by the margin (hereinafter, weighted resource amount) based on the resource amount (i.e., calculation amount, power amount, and communication amount) required for operating the actuator and the margin of the current system, and records the calculated weighted resource amount in the statistical access log. The weighted resource amount is calculated such that the weighting increases as the margin decreases. The weighted calculation amount is calculated using, for example, a CPU margin set to have a negative correlation with the usage rate of the CPU 4a. The weighted power amount is calculated using, for example, a power margin set to have a positive correlation with the charging rate of the on-vehicle battery. The weighted communication amount is calculated using, for example, a communication margin set to have a negative correlation with the communication amount per unit time.

That is, when calculating the calculation amount, the API GW 40 adds the calculation amount weighted by the margin to the “calculation amount weighted by the margin” in the third statistical access log AL3 corresponding to the executed process. When the power amount is calculated, the API GW 40 adds the power amount weighted by the margin to “the power amount weighted by the margin” in the fourth statistical access log AL4 corresponding to the executed process. When the communication amount is calculated, the API GW 40 adds the communication amount weighted by the margin to “the communication amount weighted by the margin” in the fifth statistical access log AL5 corresponding to the executed process.

Next, a description will be provided for a specific example of recording the calculation amount required for processing until detection data indicating a detection result of the sensor is passed to the service application in the process in response to the API access request to the API included in the data-system functional block group 36 (hereinafter, lead-system API).

It is assumed that a detection result of an obstacle around the vehicle is transmitted to the service application by an API access request instructing execution of a process of detecting an obstacle around the vehicle.

When there are no obstacles around the vehicle, a small calculation amount is recorded in the statistical access log, and when there are many obstacles around the vehicle, a large calculation amount is recorded in the statistical access log.

That is, the API GW 40 adds the calculated calculation amount to the “total calculation amount” in the first statistical access log AL1 corresponding to the executed process, and adds the calculated calculation amount to the “calculation amount” in third statistical access log AL3 corresponding to the executed process.

Next, a description will be provided for a specific example of recording the type, number, and actuation time of the used sensors in the process in response to the API access request to the lead-system API.

It is assumed that a detection result of an obstacle around the vehicle is transmitted to the service application by an API access request instructing execution of a process of detecting an obstacle around the vehicle.

When the surrounding obstacle is detected only by the front camera, that the front camera was used, that the number of used sensors is one, and the actuation time are recorded in the statistical access log.

When the surrounding obstacle is detected by the front camera and the millimeter wave radar, that the front camera and the millimeter wave radar were used, that the number of used sensors is two, and the actuation time are recorded in the statistical access log.

When the surrounding obstacle is detected by the front camera, the millimeter wave radar, and the Lidar, that the front camera, the millimeter wave radar, and the Lidar were used, that the number of used sensors is three, and the actuation time are recorded in the statistical access log.

When the surrounding obstacle is detected by the front camera, the millimeter wave radar, the Lidar, and the all-around camera, that the front camera, the millimeter wave radar, the Lidar, and the all-around camera were used, that the number of used sensors is four, and the actuation time are recorded in the statistical access log.

When a surrounding obstacle is detected by the front camera, the millimeter wave radar, the Lidar, the whole circumference camera, and the sonar, that the front camera, the millimeter wave radar, the Lidar, the whole circumference camera, and the sonar were used, that the number of used sensors is five, and an actuation time are recorded in the statistical access log.

That is, the API GW 40 records the type and number of used sensors in the “number of ECUs that have operated” in the first statistical access log AL1 corresponding to the executed process. The API GW 40 adds the actuation time of the used sensor to the “actuator/sensor actuation time” in the second statistical access log AL2 corresponding to the executed process.

Next, a description will be provided for a specific example of operating the sensor in the process in response to the API access request to the lead-system API and recording the type and number of ECUs or systems that have cooperated to process data.

It is assumed that a service application is placed in the cloud, and the service application transmits an API access request instructing execution of a process of detecting an obstacle around the vehicle to the API gateway 40. In this case, the cooperative operation of four ECUs 5 belonging to the domains of the cloud system, the extra-vehicle communication device 7, the ECU 4, and the body is recorded in the statistical access log.

It is assumed that a service application is placed in the ECU 4, and the service application transmits the API access request instructing execution of the process of detecting an obstacle around the vehicle to the API gateway 40. In this case, the cooperative operation of two ECUs 5 belonging to the domains of the ECU 4 and the body is recorded in the statistical access log.

It is assumed that a service application is placed in the ECU 5 belonging to the domain of the body, and the service application transmits the API access request instructing execution of the process of detecting an obstacle around the vehicle to the API gateway 40. In this case, the operation of one of the ECUs 5 belonging to the domain of the body is recorded in the statistical access log.

That is, the API GW 40 records the type and number of ECUs or systems that have cooperated to process data in the “number of ECUs that have operated” and the “number of extra-vehicle systems that have operated” in the first statistical access log AL1 corresponding to the executed process.

Next, a description will be provided for a specific example of operating the sensor and recording power consumption for processing data in the process in response to the API access request to the lead-system API.

Each time the execution of the process in response to the API access request is normally completed, the power consumption of the system, ECU, or sensor that has performed the operation related to the process is recorded in the statistical access log. When it is difficult to directly measure the power consumption, the power consumption is calculated based on a power amount table with a preset power amount per operation for each of the plurality of systems, the plurality of ECUs, or the plurality of sensors.

That is, the API GW 40 adds the calculated power consumption to the “total power amount” in the first statistical access log AL1 corresponding to the executed process, and adds the calculated power consumption to the “power amount” in fourth statistical access log AL4 corresponding to the executed process.

Next, a description will be provided for a specific example of recording a communication amount required for operating the sensor and processing data in the process in response to the API access request to the lead-system API.

Each time the execution of the process in response to the API access request is normally completed, the communication amount of the system, ECU, or sensor that has performed the operation related to the process is recorded in the statistical access log. When it is difficult to directly measure the communication amount, the communication amount is calculated based on a communication amount table with a preset communication amount per operation for each of the plurality of systems, the plurality of ECUs, or the plurality of sensors. Note that the communication amount is recorded for each type of communication path.

That is, the API GW 40 adds the calculated communication amount to the “total communication amount” in the first statistical access log AL1 corresponding to the executed process, and adds the calculated communication amount to the “communication amount” in the fifth statistical access log AL5 corresponding to the executed process.

In addition, the API GW 40 calculates a weighted resource amount based on the resource amount (i.e., calculation amount, power amount, and communication amount) required for operating the sensor and the margin of the current system, and records the calculated weighted resource amount in the statistical access log.

That is, when calculating the calculation amount, the API GW 40 adds the calculation amount weighted by the margin to the “calculation amount weighted by the margin” in the third statistical access log AL3 corresponding to the executed process. When the power amount is calculated, the API GW 40 adds the power amount weighted by the margin to “the power amount weighted by the margin” in the fourth statistical access log AL4 corresponding to the executed process. When the communication amount is calculated, the API GW 40 adds the communication amount weighted by the margin to “the communication amount weighted by the margin” in the fifth statistical access log AL5 corresponding to the executed process.

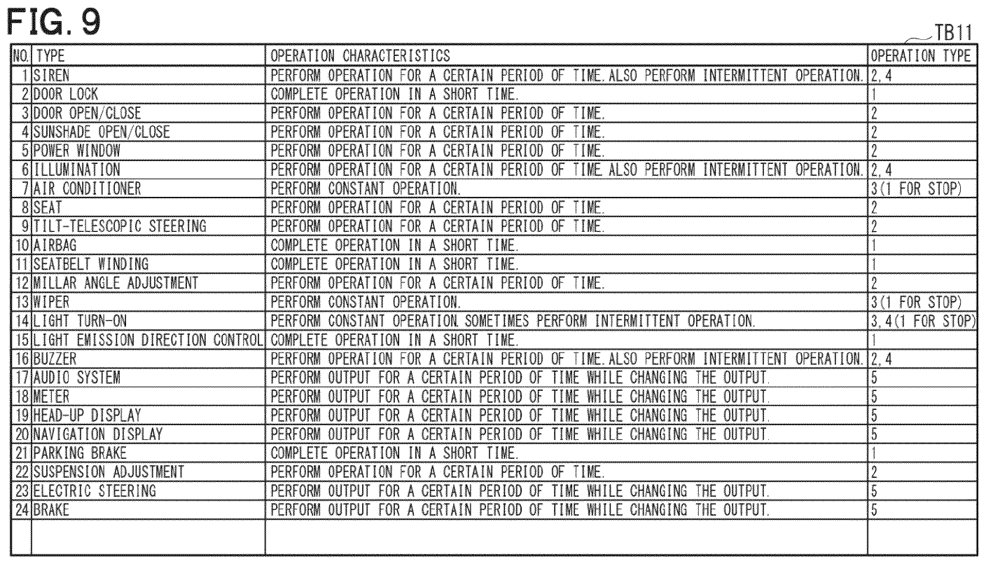

As illustrated in FIG. 9, the ROM 4b of the ECU 4 stores an actuator operation type table TB11.

The actuator operation type table TB11 associates at least one of a first operation type, a second operation type, a third operation type, a fourth operation type, a fifth operation type, or a sixth operation type with each of the plurality of actuators mounted on the vehicle.

The first operation type indicates that the operation is completed in a short time or a value is returned instantaneously.

The second operation type indicates that the operation is performed for a certain period of time.

The third operation type indicates that constant operation is performed.

The fourth operation type indicates that intermittent operation or periodic operation is performed.

The fifth operation type indicates that the amount of input/output data is variable.

The sixth operation type indicates that the result of the arithmetic processing is returned.

For example, a siren actuator is associated with the second operation type and the fourth operation type.

A door lock actuator is associated with the first operation type.

A door open/close actuator is associated with the second operation type.

An illumination actuator is associated with the second operation type and the fourth operation type.

An air conditioner actuator is associated with the third operation type. However, when the air conditioner is stopped, the air conditioner actuator is associated with the first operation type.

An audio actuator is associated with the fifth operation type.

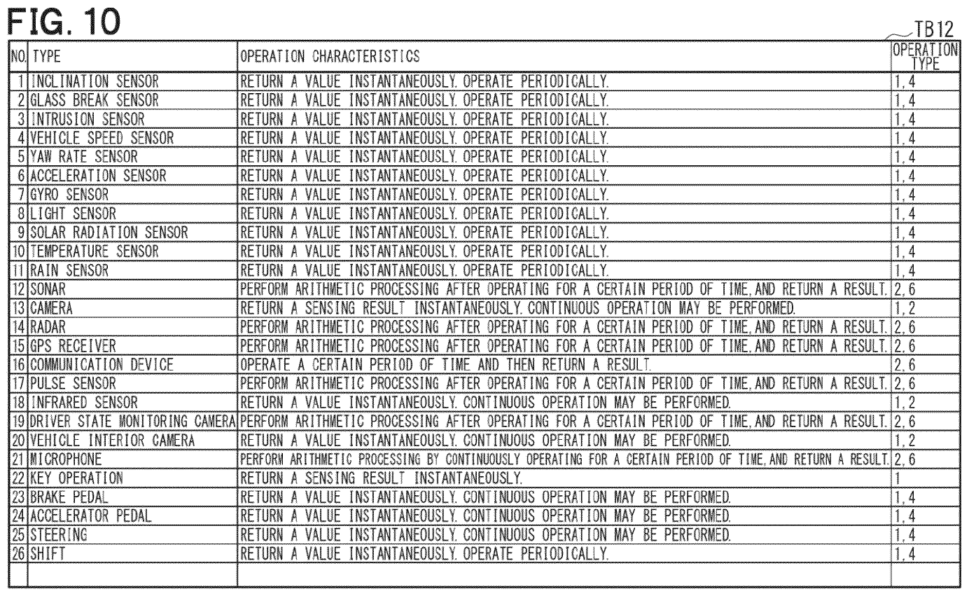

As illustrated in FIG. 10, the ROM 4b of the ECU 4 stores a sensor operation type table TB12.

The sensor operation type table TB12 associates at least one of a first operation type, a second operation type, a third operation type, a fourth operation type, a fifth operation type, or a sixth operation type with each of the plurality of sensors mounted on the vehicle.

For example, the inclination sensor is associated with the first operation type and the fourth operation type.

The sonar is associated with the second operation type and the sixth operation type.

The camera is associated with the first operation type and the second operation type.

The key operation sensor is associated with the first operation type.

Next, a procedure for the log creation process according to the second embodiment will be described.

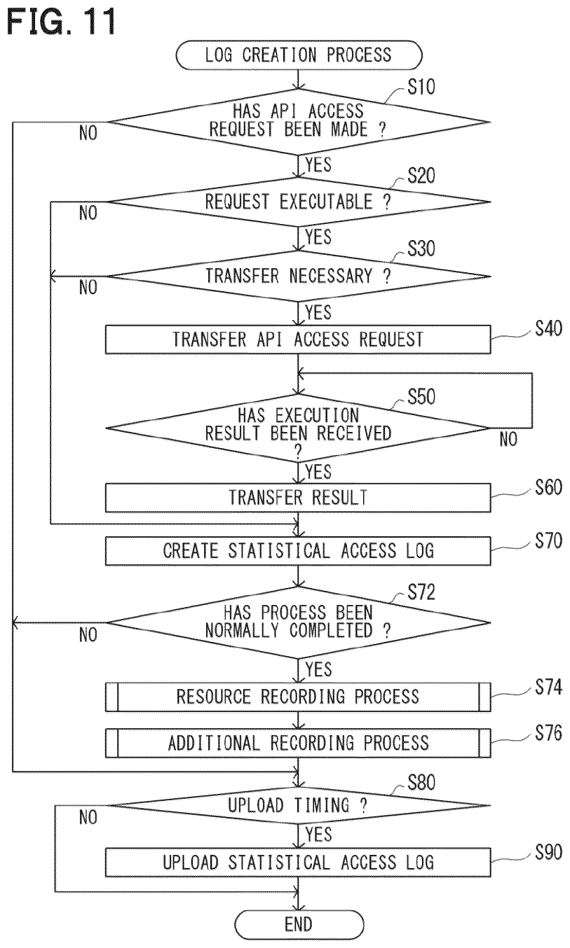

As illustrated in FIG. 11, the log creation process of the second embodiment differs from that of the first embodiment in that the processes of S72, S74, and S76 are added.

That is, when the process of S70 ends, the API GW 40 determines whether the execution of the process in response to the API access request is normally completed in S72. Here, when the execution of the process in response to the API access request is not normally completed, the API GW 40 proceeds to S80. On the other hand, when the execution of the process in response to the API access request is normally completed, the API GW 40 executes a resource recording process, which will be described later, in S74.

In S76, the API GW 40 executes an additional recording process, which will be described later, and proceeds to S80.

Next, a procedure for a resource recording process executed in S74 will be described. The resource recording process is executed for each of the actuator and the sensor used in the execution of the process in response to the API access request.

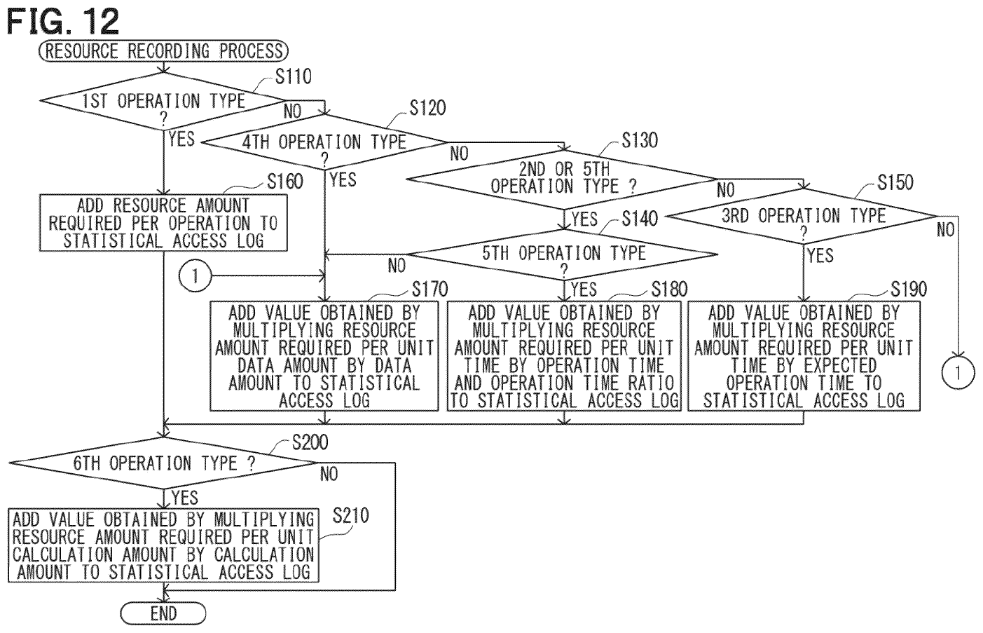

When the resource recording process is executed, as illustrated in FIG. 12, in S110, the API GW 40 determines whether the actuator or the sensor used in the execution of the process in response to the API access request has performed the operation corresponding to the first operation type. That is, the API GW 40 determines whether the used actuator or sensor completes its operation in a short time or returns a value instantaneously.

When the number of operation types associated with the actuator or the sensor is one, the API GW 40 determines whether the used actuator or sensor has performed the operation corresponding to the first operation type based on the actuator operation type table TB11 or the sensor operation type table TB12.

When there are a plurality of operation types associated with the actuator or the sensor, the API GW 40 determines whether the used actuator or sensor has performed the operation corresponding to the first operation type based on the execution result of the process in response to the API access request and the actuator operation type table TB11 or the sensor operation type table TB12.

Here, when the used actuator or sensor has performed the operation corresponding to the first operation type, the API GW 40 proceeds to S160. On the other hand, when the used actuator or sensor has not performed the operation corresponding to the first operation type, the API GW 40 determines whether the actuator or sensor used in the execution of the process in response to the API access request has performed the operation corresponding to the fourth operation type in S120. That is, the API GW 40 determines whether the used actuator or sensor has performed intermittent operation or periodical operation.

Here, when the used actuator or sensor has performed the operation corresponding to the fourth operation type, the API GW 40 proceeds to S170. On the other hand, when the used actuator or sensor has not performed the operation corresponding to the fourth operation type, the API GW 40 determines in S130 whether the actuator or sensor used in the execution of the process in response to the API access request has performed the operation corresponding to the second operation type or the fifth operation type.

Here, when the used actuator or sensor has performed the operation corresponding to the second operation type or the fifth operation type, the API GW 40 determines whether the used actuator or sensor has performed the operation corresponding to the fifth operation type in S140. That is, the API GW 40 determines whether the amount of input/output data is variable.

Here, when the used actuator or sensor has not performed the operation corresponding to the fifth operation type, the API GW 40 proceeds to S170. On the other hand, when the used actuator or sensor has performed the operation corresponding to the fifth operation type, the API GW 40 proceeds to S180.

When the used actuator or sensor has not performed the operation corresponding to the second operation type or the fifth operation type in S130, the API GW 40 determines whether the used actuator or sensor has performed the operation corresponding to the third operation type in S150. That is, the API GW 40 determines whether the sensor is the actuator or sensor that continues its operation even after completion of the process in response to the API access request.

Here, when the used actuator or sensor has not performed the operation corresponding to the third operation type, the API GW 40 proceeds to S170. On the other hand, when the used actuator or sensor has performed the operation corresponding to the third operation type, the API GW 40 proceeds to S190.

When the process proceeds to S160, the API GW 40 calculates the resource amount required per operation and adds the resource amount to the statistical access log. In addition, in S160, the API GW 40 calculates a weighted resource amount and adds the weighted resource amount to the statistical access log. The resource amount is a calculation amount, a power amount, and a communication amount. When the process of S160 ends, the API GW 40 proceeds to S200.

When the process proceeds to S170, the API GW 40 adds to the statistical access log a value obtained by multiplying the resource amount required per unit data amount by the data amount. In addition, in S170, the API GW 40 calculates a weighted resource amount and adds the weighted resource amount to the statistical access log. When the process of S170 ends, the API GW 40 proceeds to S200.

When the process proceeds to S180, the API GW 40 adds to the statistical access log a value obtained by multiplying the resource amount required per unit time by the operation time and the operation time ratio. In addition, in S180, the API GW 40 calculates a weighted resource amount and adds the weighted resource amount to the statistical access log. When the process of S180 ends, the API GW 40 proceeds to S200.

When the process proceeds to S190, the API GW 40 adds to the statistical access log a value obtained by multiplying the resource amount required per unit time by the expected operation time. In addition, in S190, the API GW 40 calculates a weighted resource amount and adds the weighted resource amount to the statistical access log. When the process of S190 ends, the API GW 40 proceeds to S200.

When the process proceeds to S200, the API GW 40 determines whether the used actuator or sensor has performed the operation corresponding to the sixth operation type. That is, the API GW 40 determines whether arithmetic processing is required in the used actuator or sensor.

Here, when the used actuator or sensor has not performed the operation corresponding to the sixth operation type, the API GW 40 ends the resource recording process. On the other hand, when the used actuator or sensor has performed the operation corresponding to the sixth operation type, in S210, the API GW 40 adds to the statistical access log a value obtained by multiplying the resource amount required per unit calculation amount by the calculation amount. In addition, in S210, the API GW 40 calculates a weighted resource amount and adds the weighted resource amount to the statistical access log. When the process of S210 ends, the API GW 40 ends the resource recording process.

Next, a procedure for the additional recording process executed in S76 will be described. The additional recording process is executed for each of the actuator and the sensor used in the execution of the process in response to the API access request.

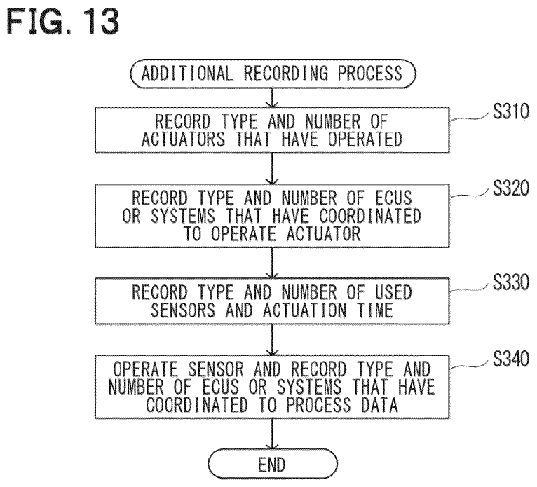

When the additional recording process is executed, the API GW 40 records the type and number of actuators that have operated in the process in response to the API access request in S310, as illustrated in FIG. 13.

In S320, the API GW 40 records the type and number of ECUs or systems that cooperate to operate the actuator in the process in response to the API access request.

In S330, the API GW 40 records the type, number, and actuation time of the used sensor in the process in response to the API access request.

In S340, in the process in response to the API access request, the API GW 40 operates the sensor, records the type and number of ECUs or systems that have cooperated to process data, and ends the additional recording process.

The application store 15 of the server 3 calculates the API usage fee by multiplying the first, second, third, fourth, and fifth statistical access logs AL1, AL2, AL3, AL4, AL5 acquired from the API GW 40 by the corresponding coefficients for each item (i.e., count, data amount, resource amount, number and time). Note that the coefficient varies for each item and also varies for each API.

The service providing system 1 as described above includes the vehicle control system 2 and the server 3.

The vehicle control system 2 is mounted on a vehicle. The vehicle control system 2 includes the on-vehicle devices 4 to 7 connected to the intra-vehicle communication network 8. The server 3 is configured to be capable of data communication with the vehicle control system 2.

The vehicle control system 2 includes the API gateway 40. The API gateway 40 is configured to implement coordination between the service-system functional block group 33, which is configured to provide a service to a vehicle, and the control-system functional block group 35 and the data-system functional block group 36, which are each configured to execute a predetermined process in the vehicle.

The control-system functional block group 35 includes the API group 37. The data-system functional block group 36 includes the API group 38. The API groups 37, 38 are configured to convert an API access request, expressed in a vehicle-independent format and transmitted from the service-system functional block group 33, into a vehicle-dependent format.

The API gateway 40 is configured to transfer the API access request transmitted from the service-system functional block group 33 to the control-system functional block group 35 and the data-system functional block group 36.

The API gateway 40 is configured to create the first statistical access log AL1 based on the execution status of the API access request by the on-vehicle devices 4 to 7.

The server 3 is configured to calculate an API usage fee generated by the service-system functional block group 33 using the API groups 37, 38 by using the first statistical access log AL1 created by the API gateway 40.

Such a service providing system 1 can calculate the API usage fee by using the number of times and the communication data amount included in the first statistical access log AL1. Therefore, the service providing system 1 can charge the service provider SV who provides a service to the vehicle.

The API gateway 40 is configured to create the first, second, third, fourth, and fifth statistical access logs AL1, AL2, AL3, AL4, AL5 that record resource consumption information regarding resources consumed in processes in response to API access requests to the API groups 37, 38 included in the control-system functional block group 35 and the data-system functional block group 36.

The resource consumption information includes the calculation amount required for operating the actuator and the calculation amount required for processing until detection data indicating a detection result of the sensor is passed to the service-system functional block group 33.

The resource consumption information includes the type and number of actuators that have operated, and the type, number, and actuation time of the sensors used.

The resource consumption information includes the type and number of a plurality of ECUs or systems that have cooperated to operate the actuator and the type and number of a plurality of ECUs or systems that have cooperated to operate the sensor and process the data.

The resource consumption information includes power consumption for operating the actuator and power consumption for operating the sensor and process data.

The resource consumption information includes the communication amount required for operating the actuator and the communication amount required for operating the sensor and process data.

The server 3 is configured to calculate the API usage fee by using the first to fifth statistical access logs AL1 to AL5 created by the API gateway 40.

Such a service providing system 1 can calculate an API usage fee according to the consumed resources. For this reason, the service providing system 1 can prevent the occurrence of a situation in which the API usage fee is the same even though the consumed resources are different, and can reduce the sense of unfairness in charging to the service provider SV.

The server 3 is configured to calculate the API usage fee by changing the weighting on the resource consumption information according to the API. Such a service providing system 1 can charge appropriately according to the API.

The server 3 is configured to calculate the API usage fee by changing the weighting on the resource consumption information according to the resource margin at the time when the resource is consumed. Such a service providing system 1 can motivate the service provider SV to use the API when the resource margin is large, so that the occurrence of a situation in which the resource margin is small can be prevented.

In the embodiment described above, S74 and S76 correspond to processes as a resource recording section, and the first to fifth statistical access logs AL1 to AL5 correspond to resource access logs.

Although one embodiment of the present disclosure has been described above, the present disclosure is not limited to the above embodiment, and various modifications can be made.

### First Modification

In the above embodiment, the form in which the calculation amount, the power amount, and the communication amount weighted by the margins are recorded has been described. However, the consumed resource amount and the resource margin at the time when the resource is consumed may be recorded in association with each other.

The ECU 4 and the technique thereof described in the present disclosure may be implemented by a dedicated computer provided by configuring a processor and a memory programmed to execute one or a plurality of functions embodied by a computer program. Alternatively, the ECU 4 and the methods described in the present disclosure may be implemented by a dedicated computer provided by configuring a processor with one or more dedicated hardware logic circuits. Alternatively, the ECU 4 and the technique thereof according to the present disclosure may be implemented using one or a plurality of dedicated computers constituted by a combination of the processor and the memory programmed to execute one or more functions and the processor with one or more hardware logic circuits. The computer program may be stored in a computer-readable non-transitional tangible recording medium as an instruction to be executed by the computer. The method for realizing the functions of the respective units included in the ECU 4 does not necessarily need to include software, and all of the functions may be realized with the use of one or multiple hardware.

Multiple functions of one configuration element in the above embodiment may be implemented by multiple configuration elements, or a single function of one configuration element may be implemented by multiple configuration elements. Multiple functions of multiple elements may be implemented by one element, one function provided by multiple elements may be implemented by one element. A part of the configuration of the above embodiments may be omitted as appropriate. At least a part of the configuration of the above embodiment may be added to or replaced with the configuration of another embodiment.

The present disclosure may be implemented, in addition to the ECU 4 described above, various forms such as a system including the ECU 4 as a component, a program for causing a computer to function as the ECU 4, a non-transitory tangible storage medium including a semiconductor memory storing the program, a service providing method.

What is claimed is:

1. A service providing system, comprising:
a vehicle control system that is mounted on a vehicle and includes a plurality of electronic control devices connected to an on-vehicle network;
a server configured to be capable of data communication with the vehicle control system,
wherein
the vehicle control system includes
a coordination control section configured to implement coordination between a service-system functional block configured to provide a service to the vehicle and a functional block configured to execute a predetermined process in the vehicle,
the functional block includes
a functional interface configured to convert an access request expressed in a vehicle-independent format and transmitted from the service-system functional block into a vehicle-dependent format,
the coordination control section includes
a request transfer section configured to transfer the access request transmitted from the service-system functional block to the functional block, and
an access log creation section configured to create, based on an execution status of the access request by each of the plurality of electronic control devices, an access log including at least one of an interface usage count that is a total number of times the service-system functional block has used the functional interface or an amount of communication data generated by the service-system functional block using the functional interface, and
the server uses the access log created by the coordination control section to calculate an interface usage fee generated by the service-system functional block using the functional interface.

2. The service providing system according to claim 1, wherein
the interface usage count includes an execution completion count that is a total number of times the plurality of electronic control devices have executed and completed a process in response to the access request.

3. The service providing system according to claim 1, wherein
the interface usage count includes an execution unnecessary occurrence count that is a total number of times execution of the process in response to the access request by the plurality of electronic control devices has been unnecessary.

4. The service providing system according to claim 1, wherein
the interface usage count includes an execution anomaly count that is a total number of times the plurality of electronic control devices is unable to execute the process in response to the access request due to occurrence of an anomaly.

5. The service providing system according to claim 1, wherein
the interface usage count includes a total number of times the plurality of electronic control devices have executed and completed the process in response to the access request in each of a plurality of vehicle states of the vehicle on which the vehicle control system is mounted.

6. The service providing system according to claim 1, wherein
the amount of communication data includes an integrated value of amounts of data acquired by the service-system functional block by the plurality of electronic control devices executing the process in response to the access request.

7. A server comprising:
a communication section configured to be capable of performing data communication with a vehicle control system that is mounted on a vehicle and includes a plurality of electronic control devices connected to an on-vehicle network, the vehicle control system further including a functional interface configured to convert an access request expressed in a vehicle-independent format into a vehicle-dependent format when the access request is received from a service-system functional block configured to provide a service to the vehicle on which the plurality of electronic control devices are mounted; and
a charging calculation section configured to use an access log to calculate an interface usage fee generated by the service-system functional block using the functional interface when the access log is received, the access log having been created based on an execution status of the access request by each of the plurality of electronic control devices to include at least one of an interface usage count that is a total number of times the service-system functional block has used the functional interface or an amount of communication data generated by the service-system functional block using the functional interface.

8. An on-vehicle device mounted on a vehicle and connected to a plurality of electronic control devices by an on-vehicle network, the on-vehicle device including:
a functional interface configured to convert an access request expressed in a vehicle-independent format into a vehicle-dependent format when the access request is received from a service-system functional block configured to provide a service to the vehicle on which the on-vehicle device is mounted;
an access log creation section configured to create, based on an execution status of the access request by each of the plurality of electronic control devices, an access log including at least one of an interface usage count that is a total number of times the service-system functional block has used the functional interface or an amount of communication data generated by the service-system functional block using the functional interface; and
a log transmission section configured to transmit the access log to a server installed outside the on-vehicle device.

9. The on-vehicle device according to claim 8, further comprising:
a functional block including the functional interface and configured to execute a predetermined process in the vehicle; and
a coordination control section configured to implement coordination between the service-system functional block and the functional block,
wherein
the coordination control section includes the access log creation section.

10. A service providing method executed by a service providing system including
a vehicle control system that is mounted on a vehicle and includes a plurality of electronic control devices connected to an on-vehicle network, and
a server configured to be capable of data communication with the vehicle control system,
the vehicle control system including a coordination control section configured to implement coordination between a service-system functional block configured to provide a service to the vehicle and a functional block configured to execute a predetermined process in the vehicle,
the functional block including a functional interface configured to convert an access request expressed in a vehicle-independent format and transmitted from the service-system functional block into a vehicle-dependent format,
the service providing method comprising:
transferring, by the coordination control section, the access request transmitted from the service-system functional block to the functional block;
creating, by the coordination control section, an access log including at least one of an interface usage count that is a total number of times the service-system functional block has used the functional interface or an amount of communication data generated by the service-system functional block using the functional interface, based on an execution status of the access request by each of the plurality of electronic control devices; and
calculating, by the server using the access log created by the coordination control section, an interface usage fee generated by the service-system functional block using the functional interface.

11. A non-transitory computer readable storage medium storing a service providing program that causes a computer to function as:
a communication section configured to be capable of performing data communication with a vehicle control system that is mounted on a vehicle and includes a plurality of electronic control devices connected to an on-vehicle network, the vehicle control system further including a functional interface configured to convert an access request expressed in a vehicle-independent format into a vehicle-dependent format when the access request is received from a service-system functional block configured to provide a service to the vehicle on which the plurality of electronic control devices are mounted; and
a charging calculation section configured to use an access log to calculate an interface usage fee generated by the service-system functional block using the functional interface when the access log is received, the access log having been created based on an execution status of the access request by each of the plurality of electronic control devices to include at least one of an interface usage count that is a total number of times the service-system functional block has used the functional interface or an amount of communication data generated by the service-system functional block using the functional interface.

12. A service providing method executed by a server of a service providing system including
a vehicle control system that is mounted on a vehicle and includes a plurality of electronic control devices connected to an on-vehicle network, the vehicle control system further including a functional interface configured to convert an access request expressed in a vehicle-independent format into a vehicle-dependent format when the access request is received from a service-system functional block configured to provide a service to the vehicle on which the plurality of electronic control devices are mounted, and
the server configured to be capable of data communication with the vehicle control system,
the service providing method comprising:
performing, by the server, data communication with the vehicle control system; and
calculating, by the server using an access log, an interface usage fee generated by the service-system functional block using the functional interface when the access log is received, the access log having been created based on an execution status of the access request by each of the plurality of electronic control devices to include at least one of an interface usage count that is a number of times the service-system functional block has used the functional interface or an amount of communication data generated by the service-system functional block using the functional interface.

13. A non-transitory computer readable storage medium storing a service providing program for causing a computer of an on-vehicle device, mounted on a vehicle and connected to a plurality of electronic control devices by an on-vehicle network, to function as:
a functional interface configured to convert an access request expressed in a vehicle-independent format into a vehicle-dependent format when the access request is received from a service-system functional block configured to provide a service to the vehicle on which the on-vehicle device is mounted;
an access log creation section configured to create, based on an execution status of the access request by each of the plurality of electronic control devices, an access log including at least one of an interface usage count that is a total number of times the service-system functional block has used the functional interface or an amount of communication data generated by the service-system functional block using the functional interface; and
a log transmission section configured to transmit the access log to a server installed outside the on-vehicle device.

14. A service providing method executed by an on-vehicle device mounted on a vehicle and connected to a plurality of electronic control devices by an on-vehicle network,
the on-vehicle device including a functional interface configured to convert an access request expressed in a vehicle-independent format into a vehicle-dependent format when the access request is received from a service-system functional block configured to provide a service to the vehicle on which the on-vehicle device is mounted,
the service providing method comprising:
creating, by the on-vehicle device, an access log including at least one of an interface usage count that is a total number of times the service-system functional block has used the functional interface or an amount of communication data generated by the service-system functional block using the functional interface, based on an execution status of the access request by each of the plurality of electronic control devices; and
transmitting, by the on-vehicle device, the access log to a server installed outside the on-vehicle device.

15. The service providing system according to claim 1, wherein
the coordination control section further includes a resource recording section configured to create a resource access log that records resource consumption information regarding a resource consumed in the process in response to the access request to the functional interface included in the functional block, and
the server is configured to calculate the interface usage fee using the resource access log created by the coordination control section.

16. The service providing system according to claim 15, wherein
the resource consumption information includes at least one of a calculation amount required for operating an actuator or a calculation amount required for processing until detection data indicating a detection result of a sensor is passed to the service-system functional block, in the process in response to the access request to the functional interface included in the functional block.

17. The service providing system according to claim 15, wherein
the resource consumption information includes at least one of:
a type and a total number of actuators that have operated; or
a type, a total number, and an actuation time of a sensor used,
in the process in response to the access request to the functional interface included in the functional block.

18. The service providing system according to claim 15, wherein
the resource consumption information includes at least one of:
a type and a total number of the plurality of electronic control devices or systems that have cooperated to operate an actuator, or
a type and a total number of the plurality of electronic control devices or systems that have cooperated to operate a sensor and process data,
in the process in response to the access request to the functional interface included in the functional block.

19. The service providing system according to claim 15, wherein
the resource consumption information includes at least one of:
power consumption for operating an actuator, or
power consumption for operating a sensor and process data,
in the process in response to the access request to the functional interface included in the functional block.

20. The service providing system according to claim 15, wherein
the resource consumption information includes at least one of:
a communication amount required for operating an actuator, or
a communication amount, required for operating a sensor and process data,
in the process in response to the access request to the functional interface included in the functional block.

21. The service providing system according to claim 15, wherein
the server is configured to calculate the interface usage fee by changing weighting on the resource consumption information according to the functional interface.

22. The service providing system according to claim 15, wherein
the server is configured to calculate the interface usage fee by changing weighting on the resource consumption information according to a margin of the resource at a time when the resource is consumed.
